(19) United States
(12) Patent Application Publication
(10) Pub. No.: US 2007/0164069 A1
(43) Pub. Date: Jul. 19, 2007

(54) Apparatus for carrying cargo

(75) Inventors: Stephen W. Threet, North Augusta, SC (US); Jack T. Mason JR., Hephzibah, GA (US)

Correspondence Address: DORITY & MANNING, P.A., POST OFFICE BOX 1449, GREENVILLE, SC, 29602-1449, US

(73) Assignee: Everthere Carriers, LLC

(21) Appl. No.: 11/335,237

(22) Filed: Jan. 19, 2006

(51) Int. Cl. B60R 11/00; B60R 9/00

(52) U.S. Cl. 224/499; 224/519; 224/527

(57) ABSTRACT

The present invention is directed to a cargo carrier for attaching to a vehicle. The cargo carrier includes a base and first and second wing assemblies. Each wing assembly has an extended position, an intermediate position, and a retracted position, and a locking mechanism secures the first and second wing assemblies in the intermediate position. In the retracted position, the wing assemblies may occupy a smaller volume than in the extended position. The cargo carrier may further include a cargo bag configured to fit on the base when the first and second wing assemblies are in the intermediate position. The cargo carrier may further include a mount connected to the base for attaching the base to the vehicle. The mount can be configured to connect to drawbars having a variety of widths.

### BACKGROUND OF THE INVENTION

It is known in the art to attach a platform to a vehicle for increasing the carrying capacity of the vehicle. The platform generally consists of a rectangular surface that attaches to a trailer or receiver hitch on the vehicle. Although the platform undesirably extends the length of the vehicle, the benefit of carrying additional cargo external to the vehicle generally outweighs the detriment of lengthening the vehicle.

When additional carrying capacity is not needed, it is desirable to store the platform in a convenient, readily accessible location. One solution, as shown in U.S. Pat. Nos. 4,744,590; 6,382,486; and 6,513,690, is to fold the platform toward the vehicle and leave the platform attached to the vehicle in this folded position. Although this solution ensures that the platform is readily accessible, the platform still adds some length to the vehicle. In addition, the folded platform may be aesthetically undesirable, or it may interfere with the vehicle's trunk or tailgate operation.

Another solution is to remove the platform from the vehicle and store the platform until needed. Although this solution restores the vehicle to its original length, the platform is generally too bulky to store inside the vehicle, and storing the platform separate from the vehicle limits the accessibility of the platform.

Therefore, the need exists for a cargo carrier that can increase the carrying capacity for a vehicle and that can also be conveniently stored with the vehicle when not in use.

### SUMMARY OF THE INVENTION

The present invention is directed in general to a cargo carrier for attaching to a vehicle. The component parts of the cargo carrier are simple and economical to manufacture, assemble, and use. Other advantages of the invention will be apparent from the following description and the attached drawings, or can be learned through practice of the invention.

In one embodiment, the cargo carrier includes a base, a first wing assembly connected to the base, and a second wing assembly connected to the base and opposite the first wing assembly. Each of the first and second wing assemblies has an extended position, an intermediate position, and a retracted position, and a locking mechanism is configured to secure the first and second wing assemblies in the intermediate position.

In particular embodiments, the locking mechanism may be further configured to secure the first and second wing assemblies in the retracted position. The cargo carrier may occupy a smaller volume when at least one of the first or second wing assemblies is in the retracted position than when both of the first and second wings are in the extended position. At least one of the first or second wing assemblies may further include a handle for carrying the cargo carrier in the retracted position.

In other particular embodiments, the cargo carrier may include a cargo bag configured to fit on the base when the first and second wing assemblies are in the intermediate position. The cargo bag may further include a strap for attaching the cargo bag to the first and second wing assemblies.

In another embodiment of the present invention, a cargo carrier for attaching to a vehicle includes a base, a first wing assembly connected to the base, and a second wing assembly connected to the base and opposite the first wing assembly. Each of the first and second wing assemblies includes an inner section connected to the base and an outer section connected to the inner section. Each of the first and second wing assemblies has an extended position in which the inner and outer sections of the first and second wing assemblies are substantially coplanar with the base and an intermediate position in which the inner sections of the first and second wing assemblies are substantially coplanar with the base and the outer sections of the first and second wing assemblies are substantially perpendicular to the base. The cargo carrier further includes a locking mechanism configured to secure the first and second wing assemblies in the intermediate position.

In yet another embodiment of the present invention, a cargo carrier for attaching to a vehicle includes a base, a first wing assembly connected to the base, and a second wing assembly connected to the base and opposite the first wing assembly. Each of the first and second wing assemblies includes an inner section connected to the base and an outer section connected to the inner section. Each of the first and second wing assemblies has an extended position in which the first and second wing assemblies are substantially coplanar with the base, an intermediate position in which the outer sections of the first and second wing assemblies are substantially perpendicular to the base, and a retracted position in which the first and second wing assemblies are substantially perpendicular to the base. The cargo carrier further includes a locking mechanism configured to secure the first and second wing assemblies in the intermediate position.

In particular embodiments, the cargo carrier may further include a mount connected to the base for attaching the cargo carrier to the vehicle. The mount may be configured to connect to a drawbar having a width between 1¼ inches and 2 inches.

In a further embodiment, a cargo carrier for attaching to a vehicle includes a carrier base defining at least one base aperture therethrough; a drawbar configured for connection to the carrier base, the drawbar defining at least one drawbar aperture therethrough; a support plate defining at least one hole therethrough and at least one protrusion depending therefrom, the protrusion configured to depend into the base aperture; and a connection device configured for attachment through the base aperture, the hole of the support plate, and the drawbar aperture such that the carrier base is secured to the drawbar. In this aspect, the drawbar defines a width between about 1¼ inches to about 2 inches.

Also in this aspect of the invention, the support plate is interchangeable with a different support plate defining at least one other hole therethrough and at least one other protrusion depending therefrom, the other hole and protrusion being different from the hole and protrusion of the support plate to accommodate a different drawbar. The other hole and protrusion of the different support plate differ from the hole and protrusion of the support plate in size, shape, or relative arrangement or combinations of these characteristics.

Further in this aspect of the invention, the cargo carrier includes a collapsible cargo carrier defining the carrier base and having a first wing assembly and a second wing assembly, the first and second wing assemblies having a retracted position, an intermediate position and an extended position, the collapsible cargo carrier occupying a smaller volume when at least one of the first or second wing assemblies is in the retracted position than when both of the first and second wings are in the extended position. At least one of the first or second wing assemblies in this aspect includes a handle for carrying the collapsible cargo carrier.

Also in this aspect of the invention, the cargo carrier includes a cargo bag configured to fit on the carrier base. An attachment strap can be includes on the cargo bag to attach the cargo bag to the cargo carrier.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of an embodiment of the present invention in the extended position;

FIG. 2A is an elevational view in cross section of a support plate taken along line 2A-2A in FIG. 1 in accordance with an aspect of the present invention;

FIG. 2B is an elevational view in cross section of another support plate similar to the support plate in FIG. 2A in accordance with a further aspect of the present invention;

FIG. 2C is an elevational view in cross section of yet another support plate similar to the support plate in FIG. 2A in accordance with a further aspect of the present invention;

FIG. 3 is a close-up perspective view of the embodiment depicted in FIG. 1;

FIG. 4 is a perspective view of the embodiment depicted in FIG. 1 in the intermediate position;

FIG. 5 is a perspective view of the embodiment depicted in FIG. 1 in the retracted position; and

FIG. 6 is a perspective view of the embodiment depicted in FIG. 4 with a cargo bag installed.

### DETAILED DESCRIPTION OF THE DISCLOSURE

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention relates to a collapsible cargo carrier that attaches to a vehicle to increase the carrying capacity of the vehicle. When not in use, the carrier folds up for convenient detachment and storage.

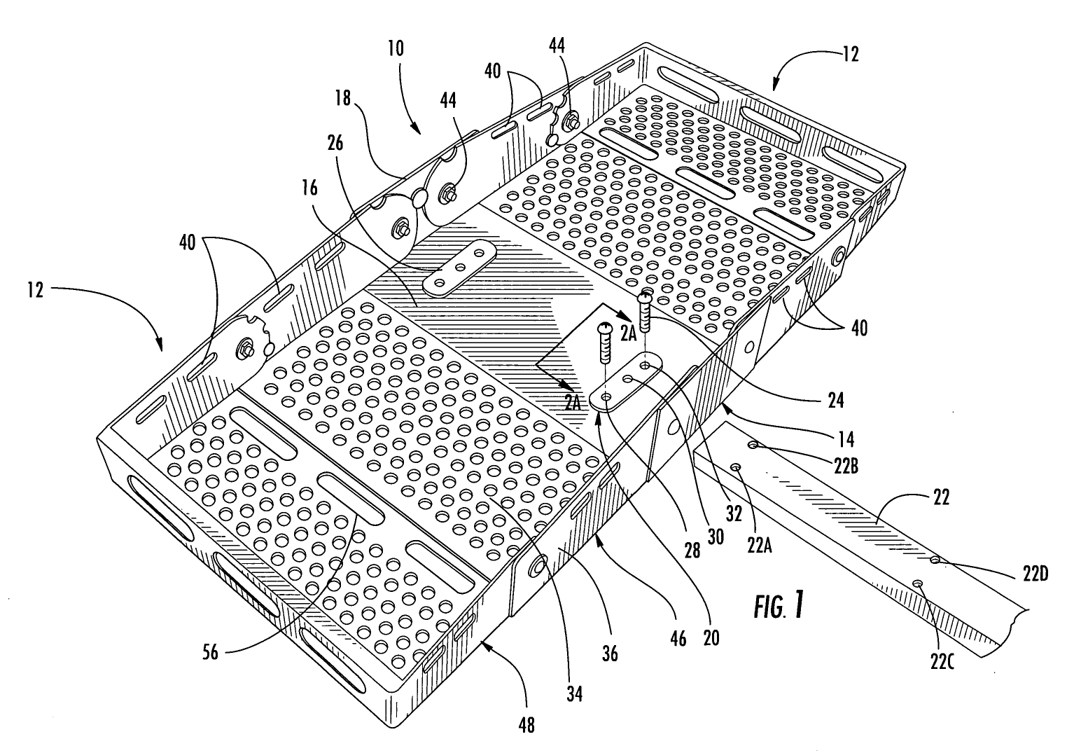

FIG. 1 illustrates a perspective view of a carrier 10 constructed according to one embodiment of the present invention. The carrier 10 generally includes wing assemblies 12 pivotally connected to opposing sides of a base 14.

The base 14 provides a sturdy foundation for attaching the wing assemblies 12 to the carrier 10 and for connecting the carrier 10 to the vehicle. The base 14 may be made of metal, plastic, fiberglass, or a combination thereof, depending on the particular uses and needs. The base 14 may include a flat surface 16, one or more sides 18, and a mount 20.

The flat surface 16 provides a portion of the surface area for carrying a desired cargo (not shown). The sides 18 provide a perimeter for the carrier 10 to aid in holding the cargo in the carrier 10 or securing the cargo to the carrier 10. The flat surface 16 and sides 18 may be solid, as shown in FIG. 1, or may include perforations or holes to reduce the weight of the carrier 10.

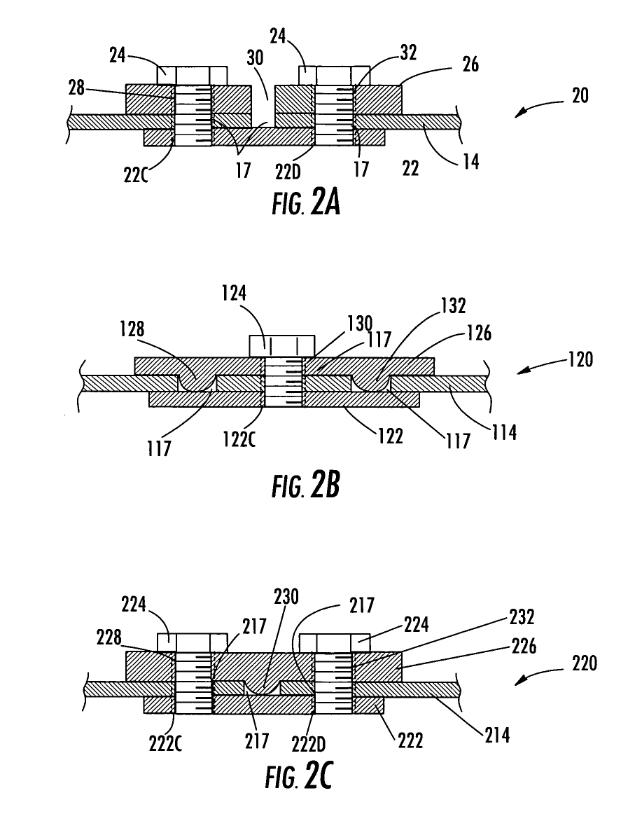

The mount 20 provides structure for attaching the carrier 10 to vehicles having various sized receivers. For instance, with reference to one embodiment shown in FIGS. 1 and 2A, the mount 20 may include a drawbar 22 bolted to the base 14 with connection devices 24 such as through-bolts, U-bolts, screws, or similar devices. The mount 20 may further include a support plate 26 with knock-out holes 28, 30, 32 to accommodate drawbars of varying sizes. As shown, if the drawbar 22 has a 2 inch width, for instance, then two through-bolts 24 may be threaded through the outer two knock-out holes 28, 32, through an aperture 17 in the base 14 and through respective drawbar apertures 22C, 22D to attach the drawbar 22 to the base 14. In this manner, the mount 20 can accommodate drawbars of varying widths.

FIGS. 1 and 2A further show that the mount 20 may include equivalent structure for attaching the carrier 10 to the vehicle. For example, the mount 20 may include the drawbar 22 suited to mate with a square collar or mounting sleeve attached to the underside of the base 14. In other words, the drawbar 22 may be shaped as a rectangle, a square, a polygon, an oval or the like and is not limited to the example shown. More particularly, as shown the square collar or mounting sleeve receives the drawbar 22, and a clevis pin, cotter pin, bolt, or other suitable structure secures the square collar or mounting sleeve to the drawbar 22. In still further embodiments, the mount 20 may be a clamp, vice grip, or other structure more suitable for securely engaging the carrier 10 to a ball-type trailer hitch.

In an alternative embodiment in some ways similar to that of FIG. 2A, a drawbar 122 is shown in FIG. 2B having a 1¼ inch width. As shown, a single through-bolt 124 is threaded through a center knock-out hole 130 of a support plate 126, through an aperture 117 in a base 114 and through a center hole 122C of the drawbar 122 to attach the drawbar 122 to the base 114. As further shown, two projections or protrusions 128, 132 are formed on the support plate 126 to help secure the support plate 126 to the base 114. More particularly, the protrusions 128, 132 extend into respective apertures 117 of the base 114 to help anchor the support plate 126 to the base 114. Thus, when the through-bolt 124 is attached as described above, the protrusions 128,132 prevent the support plate 126 from rotating about the through-bolt 124.

In yet another embodiment shown in FIG. 2C, a mount 220, which in some ways is similar to the mount 20 of FIG. 2A, can include a support plate 226 with two knock-out holes 228, 232 and a protrusion 230 to accommodate drawbars of varying sizes. As shown, the exemplary drawbar 222 has a 2 inch width. Therefore, two through-bolts 224 are threaded through the outer two knock-out holes 228, 232, through respective apertures 217 in a base 214 and through respective drawbar apertures 222C, 222D. Also shown, the protrusion 230 extends into one of the apertures 217 to attach the drawbar 222 to the base 214. The skilled artisan will instantly recognize that aspects of the embodiments shown in FIGS. 2A-2C can be modified and interchanged to accommodate various sizes of drawbars and carriers. Further, additional apertures and holes in a variety of shapes and sizes can be provided; thus, the invention is not limited to the illustrated examples.

With further reference to FIG. 1, the wing assemblies 12 provide the remainder of the surface area for carrying cargo. As shown, the wing assemblies 12 may be symmetric, or one wing assembly may be larger than the other. Furthermore, the wing assemblies may provide the majority of the surface area for carrying cargo, as shown in FIG. 1, or the base 14 may provide the majority of the surface area for carrying cargo in alternate embodiments.

In the embodiment shown in FIG. 1, each wing assembly 12 generally includes a flat surface 34, vertical sides 36, and horizontal support bars 38. The flat surface 34, vertical sides 36, and horizontal support bars 38 may be separate components that are bolted, welded, or fastened together. Alternately, the flat surface 34, vertical sides 36, and horizontal support bars 38 may be a unitary structure pressed or molded from a sheet of metal, plastic, fiberglass, or a combination thereof, depending on the particular uses and needs.

The flat surface 34 extends between the vertical sides 36 and provides additional surface area for carrying the desired cargo. The flat surface 34 may be a solid piece of material or may include perforations or holes, such as with extruded metal, to reduce the weight of the carrier 10.

The vertical sides 36 define the perimeter of the carrier 10 and may provide additional structural support for the wing assemblies 12. The vertical sides 36 may include slits 40 or holes to provide attachment points for strapping articles to the carrier 10 and to further reduce the weight of the carrier 10.

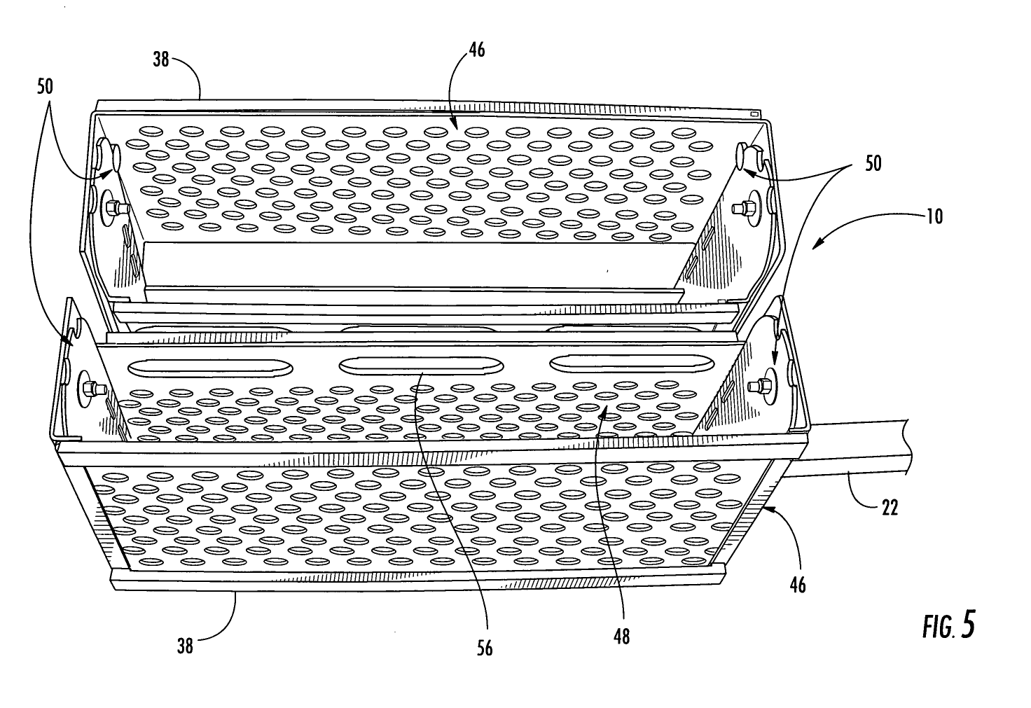

The horizontal support bars 38 (seen most clearly in FIG. 5) extend between the vertical sides 36 and provide structural support for the flat surface 34. The horizontal support bars 38 may attach directly to the vertical sides 36 using rivets, bolts, tack welds, or similar suitable methods. Alternately, the horizontal support bars 38 may attach to a support flange on the vertical sides 36. The flat surface 34 then attaches to the horizontal support bars 38 and/or vertical sides 36 in similar fashion. It should be understood by one of ordinary skill in the art that alternate embodiments within the scope of the present invention may employ other methods for connecting the flat surface 34, vertical sides 36, and horizontal support bars 38 together.

Each wing assembly 12 pivotally connects to opposing sides of the base 14 at attachment points 44. Each wing assembly 12 may further include an inner section 46 pivotally connected to an outer section 48 at additional attachment points 44, as shown in FIG. 1. The attachment points 44 secure each wing assembly 12 to the base 14 and each inner section 46 to the associated outer section 48 while still allowing pivotal movement between the respective components. The attachment points 44 may include rivets, bolts, hinges, or other suitable structure for permitting pivotal movement between the respective components.

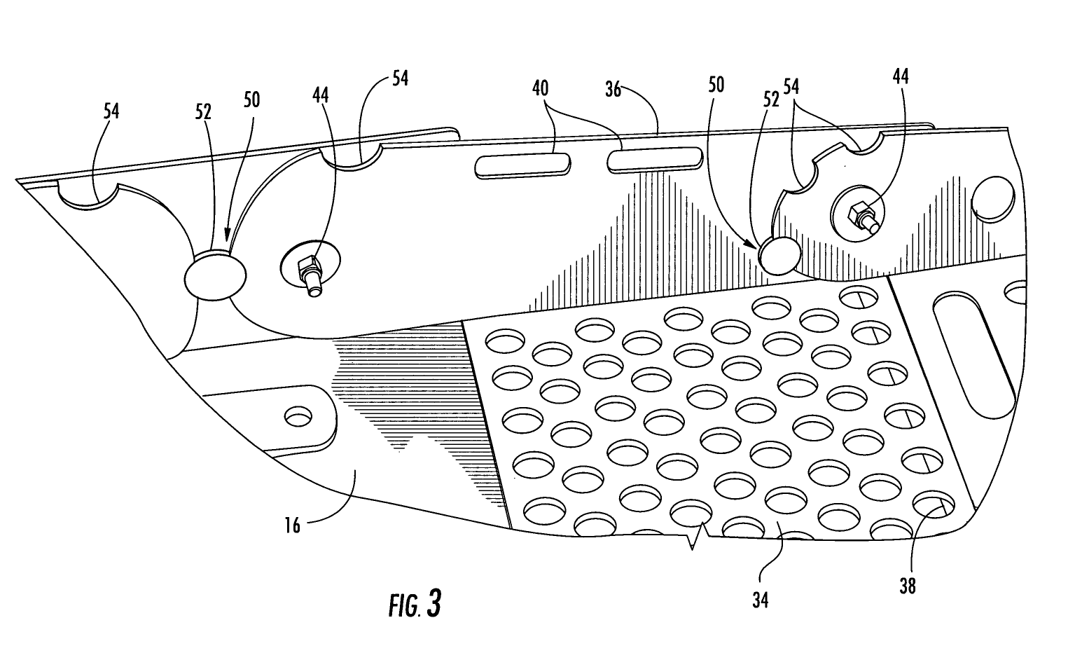

FIG. 3 provides a close-up view of the attachment points 44 shown in FIG. 1. The attachment points 44 may use rivets, bolts, hinges, slides, or other suitable substitutes. In alternate embodiments, the attachment points 44 may be located on other parts of the wing assembly 12, such as on the underside of the flat surface 34 and/or on the horizontal support bars 38.

As shown in FIG. 3, the attachment points 44 may include locking mechanisms 50 for securing the wing assemblies 12 in a desired position. The locking mechanisms 50 shown in FIG. 3 include spring-biased buttons 52 that fit into detents 54 in the vertical sides 36 corresponding to desired positions for the wing assemblies 12. To move the wing assembly 12 to another desired position, one simply depresses the button 52 to disengage the button 52 from the detent 54. The wing assembly 12 can then pivot to another desired position where the spring-biased button 52 again engages with the detent 54. Alternate embodiments may include other suitable mechanisms, such as a ratchet wheel, for locking the wing assemblies in various positions.

FIGS. 1, 4, and 5 illustrate one embodiment of the present invention with the wing assemblies 12 in various positions. FIG. 1 shows the carrier 10 in an extended position, as it would be when installed on a vehicle. The extended position provides the maximum surface area on the carrier 10 for carrying cargo. In the extended position, the locking mechanism 50 secures the wing assembly 12 horizontally and substantially co-planar with the base 14. The outer section 48 of the wing assembly 12, if present, may be similarly locked in a horizontal position.

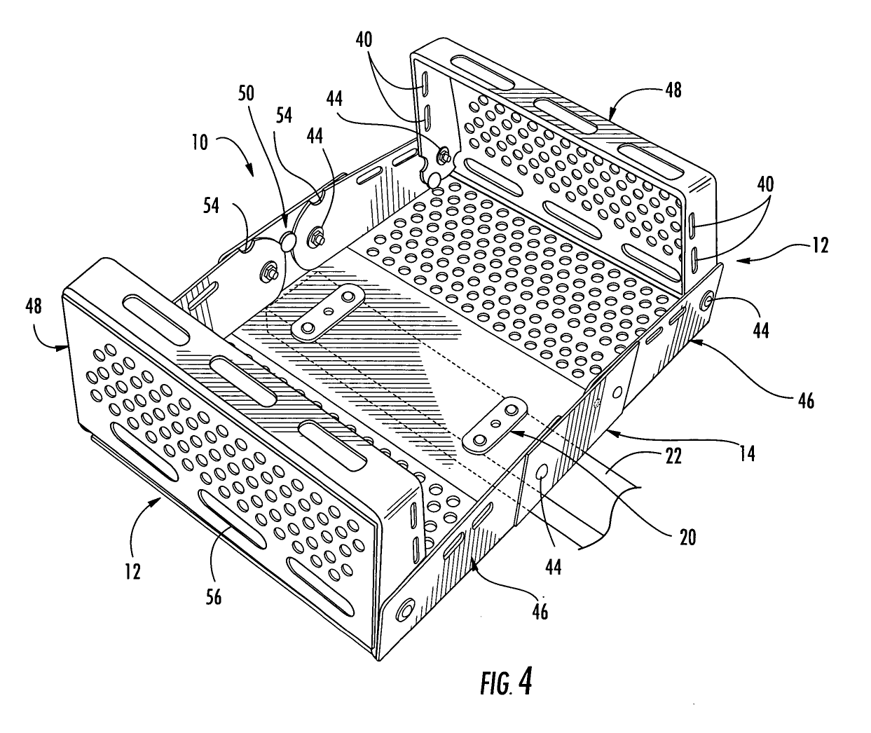

FIG. 4 shows the carrier 10 in an intermediate position. The intermediate position may be useful to prevent the cargo from shifting or sliding on the carrier 10 while in transport. In the intermediate position, the outer section 48 of each wing assembly 12 pivots to a vertical position, substantially perpendicular to the base 14, and the locking mechanisms 50 secure the outer sections 48 of the wing assemblies 12 in the intermediate position.

FIG. 5 shows the carrier 10 in a retracted position, as it would be when installing or removing the carrier 10 or when the carrier 10 is being stored. In the retracted position, the outer section 48, if present, pivots completely into the inner section 46, and the inner section 46 pivots to a vertical position, substantially perpendicular to the base 14. The locking mechanisms 50 may secure the outer section 48 and/or inner section 46 in the retracted position. As shown in FIG. 5, suitably sized apertures 56 in the outer sections 48 serve as convenient handles for carrying the carrier 10 in the retracted position.

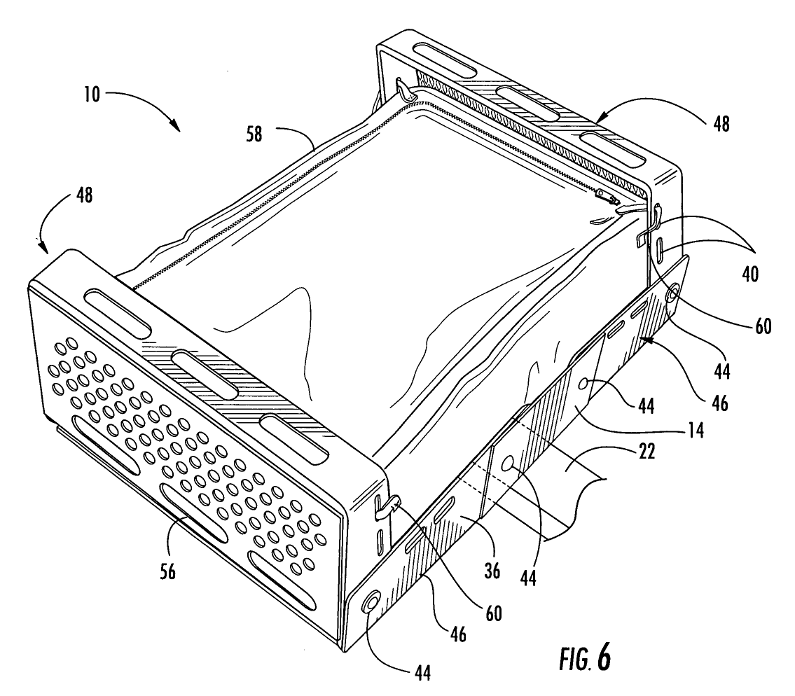

FIG. 6 shows the carrier 10 in the intermediate position with a cargo bag 58 used in conjunction with the carrier 10. The cargo bag 58 protects the cargo from the elements. In some embodiments, the cargo bag 58 can be an insulated bag for keeping cargo hot or cold. In other embodiments, the cargo bag 58 may be sized to also serve as a carrying or storage bag for the carrier 10 when the carrier 10 is in the retracted position.

The cargo bag 58 may attach to the carrier 10 using various devices known in the art. For example, the cargo bag 58 may include straps 60 that secure the cargo bag 58 to the carrier 10, as shown in FIG. 6. The straps 60 may include snaps, hook and loop fasteners, clips, clamps, or the like, to secure the cargo bag 58 to the carrier 10. Locating the straps 60 at corners of the cargo bag 58 holds the cargo bag 58 in an expanded posture to facilitate loading and unloading.

It should be appreciated by those skilled in the art that modifications and variations can be made to the embodiments of the invention set forth herein without departing from the scope and spirit of the invention as set forth in the appended claims and their equivalents.

What is claimed is:

1. A cargo carrier for attaching to a vehicle, comprising:
a base;
a first wing assembly connected to the base;
a second wing assembly connected to the base, the second wing assembly disposed opposite the first wing assembly, wherein each of the first and second wing assemblies define an extended position, an intermediate position, and a retracted position; and
a locking mechanism configured to secure the first and second wing assemblies in the intermediate position.

2. The cargo carrier as in claim 1, wherein the locking mechanism is further configured to secure the first and second wing assemblies in the retracted position.

3. The cargo carrier as in claim 1, wherein the cargo carrier occupies a smaller volume when at least one of the first or second wing assemblies is in the retracted position than when both of the first and second wings are in the extended position.

4. The cargo carrier as in claim 1, further including a mount configured for connection to the base for attaching the cargo carrier to the vehicle.

5. The cargo carrier as in claim 4, wherein the mount defines at least one aperture therethrough and at least one protrusion, the aperture and the protrusion being configured to connect the cargo carrier to the vehicle.

6. The cargo carrier as in claim 1, wherein at least one of the first or second wing assemblies includes a handle for carrying the cargo carrier in the retracted position.

7. The cargo carrier as in claim 1, further including a cargo bag configured to fit on the base when the first and second wing assemblies are in the intermediate position.

8. The cargo carrier as in claim 7, further including a strap on the cargo bag for attaching the cargo bag to the first and second wing assemblies.

9. A cargo carrier for attaching to a vehicle, comprising:
a base;
a first wing assembly connected to the base;
a second wing assembly connected to the base and opposite the first wing assembly, wherein each of the first and second wing assemblies includes an inner section connected to the base and an outer section connected to the inner section, and wherein each of the first and second wing assemblies defines an extended position in which the inner and outer sections of the first and second wing assemblies are substantially coplanar with the base, and an intermediate position in which the inner sections of the first and second wing assemblies are substantially coplanar with the base and the outer sections of the first and second wing assemblies are substantially perpendicular to the base; and
a locking mechanism configured to secure the first and second wing assemblies in the intermediate position.

10. The cargo carrier as in claim 9, wherein each of the first and second wing assemblies has a retracted position in which the first and second wing assemblies are substantially perpendicular to the base.

11. The cargo carrier as in claim 10, wherein the locking mechanism is further configured to secure the first and second wing assemblies in the retracted position.

12. The cargo carrier as in claim 10, wherein the cargo carrier occupies a smaller volume when at least one of the first or second wing assemblies is in the retracted position than when both of the first and second wings are in the extended position.

13. The cargo carrier as in claim 10, wherein at least one of the first or second wing assemblies includes a handle for carrying the cargo carrier in the retracted position.

14. The cargo carrier as in claim 9, further including a cargo bag configured to fit on the base when the first and second wing assemblies are in the intermediate position.

15. The cargo carrier as in claim 14, further including a strap on the cargo bag for attaching the cargo bag to the first and second wing assemblies.

16. A cargo carrier for attaching to a vehicle, comprising:
a carrier base defining at least one base aperture therethrough;
a drawbar configured for connection to the carrier base, the drawbar defining at least one drawbar aperture therethrough;
a support plate defining at least one hole therethrough and at least one protrusion depending therefrom, the protrusion configured to depend into the base aperture; and
a connection device configured for attachment through the base aperture, the hole of the support plate, and the drawbar aperture such that the carrier base is secured to the drawbar.

17. The cargo carrier as in claim 16, wherein the drawbar defines a width between about 1¼ inches to about 2 inches.

18. The cargo carrier as in claim 16, wherein the support plate is interchangeable with a different support plate defining at least one other hole therethrough and at least one other protrusion depending therefrom, the other hole and protrusion being different from the hole and protrusion of the support plate to accommodate a different drawbar.

19. The cargo carrier as in claim 18, wherein the other hole and protrusion of the different support plate differ from the hole and protrusion of the support plate in size, shape, or relative arrangement or combinations thereof.

20. The cargo carrier as in claim 16, further comprising a first wing assembly and a second wing assembly attached to the carrier base to define a collapsible cargo carrier, the first and second wing assemblies having a retracted position, an intermediate position and an extended position, the collapsible cargo carrier occupying a smaller volume when at least one of the first or second wing assemblies is in the retracted position than when both of the first and second wings are in the extended position.

21. The cargo carrier as in claim 20, wherein at least one of the first or second wing assemblies includes a handle for carrying the collapsible cargo carrier.

22. The cargo carrier as in claim 16, further comprising a cargo bag configured to fit on the carrier base.

23. The cargo carrier as in claim 22, further comprising an attachment strap disposed on the cargo bag.
